(19) United States
(12) Patent Application Publication
(10) Pub. No.: US 2022/0146662 A1
(43) Pub. Date: May 12, 2022

(54) INFORMATION PROCESSING APPARATUS AND INFORMATION PROCESSING METHOD

(71) Applicant: SONY GROUP CORPORATION, TOKYO (JP)

(72) Inventor: HIDEKAZU WATANABE, TOKYO (JP)

(21) Appl. No.: 17/435,122

(22) PCT Filed: Mar. 12, 2019
(86) PCT No.: PCT/JP2019/009936

§ 371 Date: Aug. 31, 2021

(51) Int. Cl. G01S 13/88; G08B 21/02; H04M 1/72454; H04M 1/72457; G06N 3/08; G01P 15/00

(52) U.S. Cl. CPC G01S 13/88; G08B 21/02; H04M 1/72454; H04M 2250/12; G06N 3/08; G01P 15/00; H04M 1/72457

(57) ABSTRACT

[Object]

A technique that, while reducing power consumption of a sensor, enables determination of whether or not a dangerous situation is present is desirably provided.

[Solving Means]

Provided is an information processing apparatus including a determination section that determines whether or not a dangerous situation is present within a predetermined measurement range, on the basis of a detection result of a millimeter wave sequentially radiated in different directions within the measurement range by beamforming, and a presentation control section that performs, in a case where the determination section determines that the dangerous situation is present within the measurement range, control such that predetermined presentation information is presented.

### TECHNICAL FIELD

The present disclosure relates to an information processing apparatus and an information processing method.

### BACKGROUND ART

In recent years, techniques for determining whether or not a dangerous situation is present have been available (see, for example, PTL 1). For example, there are known techniques in which whether or not a dangerous situation is present is determined on the basis of image data captured by an image sensor. Alternatively, there are known techniques in which whether or not a dangerous situation is present is determined on the basis of a user position detected by a sensor for position measurement (for example, a GPS (Global Positioning System) sensor or the like).

### CITATION LIST

### Patent Literature

[PTL 1]

JP 2016-224619A

### SUMMARY

### Technical Problem

However, in the techniques in which whether or not a dangerous situation is present is determined on the basis of image data captured by the image sensor or the user position detected by the sensor for position measurement, the sensor is likely to consume a large amount of power. Thus, it is desirable to provide a technique that, while reducing power consumption of the sensor, enables determination of whether or not a dangerous situation is present.

### Solution to Problem

According to the present disclosure, provided is an information processing apparatus including a determination section that determines whether or not a dangerous situation is present within a predetermined measurement range, on the basis of a detection result of a millimeter wave sequentially radiated in different directions within the measurement range by beamforming, and a presentation control section that performs, in a case where the determination section determines that the dangerous situation is present within the measurement range, control such that predetermined presentation information is presented.

According to the present disclosure, provided is an information processing method including determining whether or not a dangerous situation is present within a predetermined measurement range, on the basis of a detection result of a millimeter wave sequentially radiated in different directions within the measurement range by beamforming, and performing, in a case of determining that the dangerous situation is present within the measurement range, control such that predetermined presentation information is presented.

### BRIEF DESCRIPTION OF DRAWINGS

FIG. 1 is a diagram illustrating an overview of an embodiment of the present disclosure.

FIG. 2 is a diagram illustrating the overview of the embodiment of the present disclosure.

FIG. 3 is a diagram depicting a configuration example of a system according to the embodiment of the present disclosure.

FIG. 4 is a diagram depicting an example of a functional configuration of a smartphone according to the embodiment of the present disclosure.

FIG. 5 is a diagram depicting an example of a functional configuration of a learning apparatus according to the embodiment of the present disclosure.

FIG. 6 is a diagram depicting an example of a case where no dangerous situation is present.

FIG. 7 is a diagram depicting an example of an identification radar map that is detected in a case where no dangerous situation is present.

FIG. 8 is a diagram depicting an example of a case where a dangerous situation is present.

FIG. 9 is a diagram depicting an example of an identification radar map that is detected in a case where a dangerous situation is present.

FIG. 10 is a diagram depicting another example of a case where a dangerous situation is present.

FIG. 11 is a diagram depicting an example of an identification radar map that is detected in a case where a dangerous situation is present.

FIG. 12 is a diagram illustrating a case where an orientation of the smartphone is changed.

FIG. 13 is a diagram illustrating a case where the orientation of the smartphone is changed.

FIG. 14 is a flowchart depicting an operation example of the system according to the embodiment of the present disclosure.

FIG. 15 illustrates a hardware configuration of the smartphone according to the embodiment of the present disclosure.

### DESCRIPTION OF EMBODIMENT

A preferred embodiment of the present disclosure will be described below in detail with reference to the accompanying drawings. Note that, in the present specification and drawings, components having substantially the same functional configurations are assigned the same reference signs, and duplicate descriptions thereof are omitted.

Additionally, in the present specification and drawings, multiple components having substantially the same or similar functional configurations may be distinguished from one another by adding different numbers at the end of the same reference sign, in some cases. However, in a case where multiple components having substantially the same or similar functional configurations need not particularly be distinguished from one another, only the same reference sign is assigned to the components. Additionally, similar components in different embodiments may be distinguished from one another by adding different alphabets at the end of the same reference sign, in some cases. However, in a case where similar components need not particularly be distinguished from one another, only the same reference sign is assigned to the components.

Note that the description is given in the following order.

0. Overview

1. Details of Embodiment
1.1. System Configuration Example
1.2. Functional Configuration Example
1.3. Details of Functions of System
1.4. Operation Example of System
2. Hardware Configuration Example
3. Conclusion

### 0. OVERVIEW

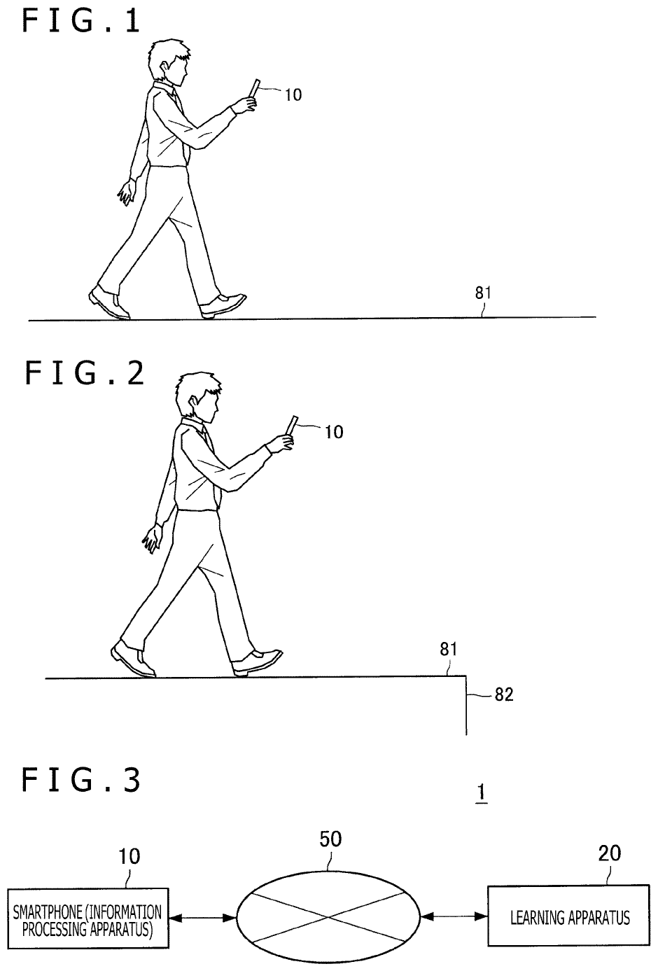

First, the embodiment of the present disclosure will be described in brief. FIG. 1 and FIG. 2 are diagrams illustrating an overview of the embodiment of the present disclosure. Referring to FIG. 1 and FIG. 2, with a smartphone 10 in a hand, a user is walking on ground 81 while watching a screen of the smartphone 10. In the example depicted in FIG. 1, no dangerous situation is present ahead of the user. On the other hand, in the example depicted in FIG. 2, since a step 82 is present ahead of the user, a dangerous situation is present ahead of the user.

In recent years, techniques for determining whether or not such a dangerous situation is present have been available. For example, there are known techniques in which whether or not a dangerous situation is present is determined on the basis of image data captured by an image sensor. Alternatively, there are known techniques in which whether or not a dangerous situation is present is determined on the basis of a user position detected by a sensor for position measurement (for example, a GPS sensor or the like).

However, in the techniques in which whether or not a dangerous situation is present is determined on the basis of image data captured by the image sensor or the user position detected by the sensor for position measurement, the sensor is likely to consume a large amount of power. Thus, in the embodiment of the present disclosure, mainly proposed is a technique that, while reducing power consumption of the sensor, enables determination of whether or not a dangerous situation is present. Additionally, in the embodiment of the present disclosure, proposed is a technique that uses a small-scale sensor to enable determination of whether or not a dangerous situation is present. Further, in the embodiment of the present disclosure, proposed is a technique that, while improving responsiveness of the sensor, enables determination of whether or not a dangerous situation is present.

Additionally, in the embodiment of the present disclosure, proposed is a technique that enables a reduction in processing time required for determining whether or not a dangerous situation is present. Further, in a case where the sensor for position measurement is used, measuring the user position may be difficult depending on where the user is. In the embodiment of the present disclosure, proposed is a technique that enables more reliable determination of whether or not a dangerous situation is present.

The embodiment of the present disclosure has been described in brief above.

### 1. DETAILS OF EMBODIMENT

Now, the embodiment of the present disclosure will be described in detail.

### [1.1. System Configuration Example]

First, a configuration example of a system according to the embodiment of the present disclosure will be described. FIG. 3 is a diagram depicting a configuration example of a system 1 according to the embodiment of the present disclosure. As depicted in FIG. 3, the system 1 according to the embodiment of the present disclosure includes the smartphone 10, a learning apparatus 20, and a network 50. The type of the network 50 is not limited to any particular type. For example, the network 50 may include the Internet.

The smartphone 10 is a terminal that can be carried by a user. In the embodiment of the present disclosure, a case where the smartphone 10 is carried by the user is mainly assumed. However, instead of the smartphone 10, another terminal (for example, a cellular phone, a tablet terminal, or the like) may be carried by the user. Alternatively, for example, in a case where a user with poor eyesight walks with a stick, the stick may assume the functions of the smartphone 10. The smartphone 10 is connected to the network 50 and configured to be communicable with another apparatus via the network 50. Note that the smartphone 10 may function as an information processing apparatus that determines whether or not a dangerous situation is present.

The learning apparatus 20 includes a computer and executes learning processing by machine learning. The learning apparatus 20 provides learning results to the smartphone 10 via the network 50. In the embodiment of the present disclosure, a case where the learning apparatus 20 trains a neural network through deep learning and provides the trained neural network to the smartphone 10 via the network 50 is assumed. However, the type of the machine learning is not limited to the deep learning. Note that, in the embodiment of the present disclosure, a case where the learning apparatus 20 is provided as an apparatus separated from the smartphone 10 is mainly assumed. However, the learning apparatus 20 may be integrated with the smartphone 10. In other words, the smartphone 10 may have the functions of the learning apparatus 20.

The configuration example of the system 1 according to the embodiment of the present disclosure has been described above.

### [1.2. Functional Configuration Example]

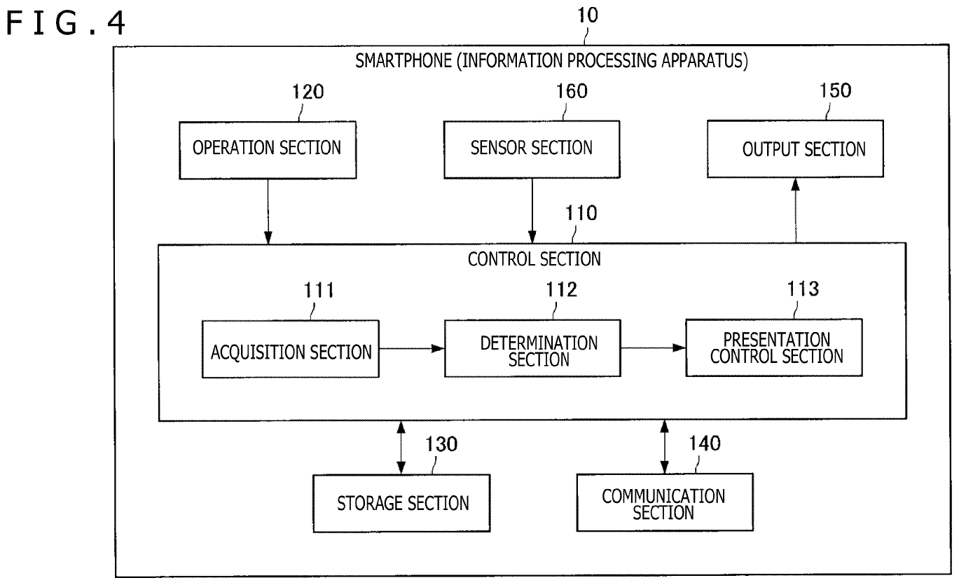

Now, a functional configuration example of the smartphone 10 according to the embodiment of the present disclosure will be described. FIG. 4 is a diagram depicting an example of the functional configuration of the smartphone 10 according to the embodiment of the present disclosure. As depicted in FIG. 4, the smartphone 10 according to the embodiment of the present disclosure includes a control section 110, an operation section 120, a storage section 130, a communication section 140, an output section 150, and a sensor section 160.

Note that, in the present specification, an example in which the control section 110, the operation section 120, the storage section 130, the communication section 140, the output section 150, and the sensor section 160 are provided inside the same device (smartphone 10) will mainly be described. However, positions where these blocks are present are not limited to any particular position. For example, as described below, some of the blocks may be present in a server or the like.

The control section 110 controls the respective sections of the smartphone 10. As depicted in FIG. 4, the control section 110 includes an acquisition section 111, a determination section 112, and a presentation control section 113. The details of the respective functional blocks will be described below. Note that the control section 110 may include, for example, a CPU (Central Processing Unit) or the like. In a case where the control section 110 includes a processing device such as a CPU, the processing device may include an electronic circuit.

The operation section 120 has a function of receiving input of an operation by the user. In the embodiment of the present disclosure, a case where the operation section 120 includes a touch panel is mainly assumed. However, the operation section 120 is not limited to the one in the case where the operation section 120 includes the touch panel. For example, the operation section 120 may include an electronic pen, may include a mouse and a keyboard, or may include an image sensor that detects a line of sight of the user.

The storage section 130 is a recording medium that stores programs to be executed by the control section 110 and data required to execute the programs. Additionally, the storage section 130 temporarily stores data for calculation by the control section 110. The storage section 130 may be a magnetic storage section device, a semiconductor storage device, an optical storage device, or a magneto-optical storage device.

The communication section 140 includes a communication circuit and has a function of communicating with another apparatus. For example, the communication section 140 has a function of acquiring data from the other apparatus and providing data to the other apparatus. In the embodiment of the present disclosure, a case where the communication section 140 includes an antenna used to communicate wirelessly with another apparatus via the network is assumed. Additionally, in the embodiment of the present disclosure, a case where the communication section 140 includes an antenna used to communicate with another apparatus by near-field wireless communication based on Bluetooth (registered trademark) or the like is assumed.

The output section 150 outputs various pieces of information. In the embodiment of the present disclosure, a case where the output section 150 includes a display that can provide display visible to the user is mainly assumed. The display may be a liquid crystal display or an organic EL (Electro-Luminescence) display. However, the output section 150 may include a sound output device or may include a haptic-sense presentation device that presents a haptic sense to the user.

The sensor section 160 includes various sensors and can obtain various pieces of sensor data through sensing performed by the sensors. In the embodiment of the present disclosure, a case where the sensor section 160 includes a millimeter-wave radar is assumed. The millimeter-wave radar sequentially radiates a millimeter wave in different directions within a predetermined measurement range by beamforming, and detects the millimeter wave reflected by an object. Note that the frequency of the millimeter wave is not limited to any particular frequency. For example, the millimeter wave may be a radio wave with a frequency ranging from 30 to 300 GHz. However, the millimeter wave may include a radio wave used in a fifth generation mobile communication system (5G) (for example, a radio wave with a frequency ranging from 27.5 to 29.5 GHz).

The example of the functional configuration of the smartphone 10 according to the embodiment of the present disclosure has been described above.

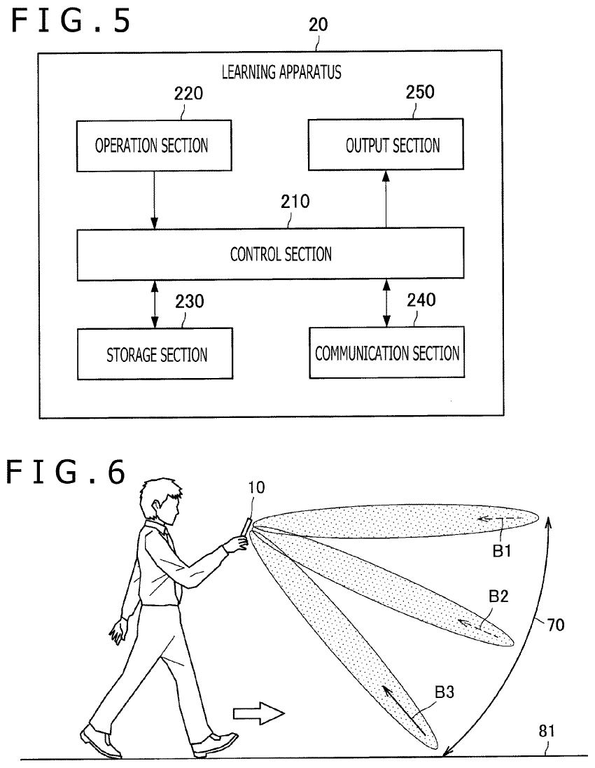

Now, an example of a functional configuration of the learning apparatus 20 according to the embodiment of the present disclosure will be described. FIG. 5 is a diagram depicting the example of the functional configuration of the learning apparatus 20 according to the embodiment of the present disclosure. As depicted in FIG. 5, the learning apparatus 20 according to the embodiment of the present disclosure includes a control section 210, an operation section 220, a storage section 230, a communication section 240, and an output section 250.

Note that, in the present specification, an example in which the control section 210, the operation section 220, the storage section 230, the communication section 240, and the output section 250 are provided inside the same device (learning apparatus 20) will mainly be described. However, positions where these blocks are present are not limited to any particular position. For example, as described below, some of the blocks may be present in a server or the like.

The control section 210 controls the respective sections of the learning apparatus 20. Note that the control section 210 may include, for example, a CPU (Central Processing Unit) or the like. In a case where the control section 210 includes a processing device such as a CPU, the processing device may include an electronic circuit.

The operation section 220 has a function of receiving input of an operation by a developer. In the embodiment of the present disclosure, a case where the operation section 220 includes a mouse and a keyboard is mainly assumed. However, the operation section 220 is not limited to the one in the case where the operation section 220 includes the mouse and the keyboard. For example, the operation section 220 may include an electronic pen, a touch panel, or an image sensor that detects a line of sight of the developer.

The storage section 230 is a recording medium that stores programs to be executed by the control section 210 and data required to execute the programs. Additionally, the storage section 230 temporarily stores data for calculation by the control section 210. The storage section 230 may be a magnetic storage section device, a semiconductor storage device, an optical storage device, or a magneto-optical storage device.

The communication section 240 includes a communication circuit and has a function of communicating with another apparatus. For example, the communication section 240 has a function of acquiring data from the other apparatus and providing data to the other apparatus. In the embodiment of the present disclosure, a case where the communication section 240 includes an antenna used to communicate wirelessly with another apparatus via the network is assumed. Additionally, in the embodiment of the present disclosure, a case where the communication section 240 includes an antenna used to communicate with another apparatus by near-field wireless communication based on Bluetooth (registered trademark) or the like is assumed.

The output section 250 outputs various pieces of information. In the embodiment of the present disclosure, a case where the output section 250 includes a display that can provide display visible to the user is mainly assumed. The display may be a liquid crystal display or an organic EL (Electro-Luminescence) display. However, the output section 250 may include a sound output device or may include a haptic-sense presentation device that presents a haptic sense to the developer.

The example of the functional configuration of the learning apparatus 20 according to the embodiment of the present disclosure has been disclosed above.

### [1.3. Details of Functions of System]

Now, details of functions of the system 1 according to the embodiment of the present disclosure will be described.

First, the learning apparatus 20 trains a neural network through deep learning. More specifically, when multiple millimeter-wave radar maps (hereinafter also referred to as “training radar maps”) on each of which a dangerous situation is detected are input, the storage section 230 accumulates the training radar maps. The control section 210 inputs the training radar maps to the neural network and trains the neural network. Thus, a trained neural network is generated.

Further, in the embodiment of the present disclosure, a case where the developer inputs, as training data, the types of dangers corresponding to the respective training radar maps is assumed. In such a case, the operation section 220 receives the multiple training radar maps and the types of dangers corresponding to the respective training radar maps, and the control section 210 inputs, to the neural network, the multiple training radar maps and the types of dangers corresponding to the respective training radar maps, and trains the neural network on the basis of the multiple training radar maps, by using the types of dangers as training data. Thus, a trained neural network that can identify the types of dangers is generated.

Note that, in the embodiment of the present disclosure, as the type of a danger, the presence of a step is mainly assumed. Typically, the step may include a step (drop) between a platform in a station and a railway track. However, the type of the danger is not limited to the presence of a step. For example, the type of the danger may include the presence of stairs, the presence of a hole, or the like.

Alternatively, the developer may input, as training data, positions where dangerous situations corresponding to the respective training radar maps are present. In such a case, the operation section 220 receives the multiple training radar maps and the positions where dangerous situations corresponding to the respective training radar maps are present, and the control section 210 inputs, to the neural network, the multiple training radar maps and the positions where dangerous situations corresponding to the respective training radar maps are present, and trains the neural network on the basis of the multiple training radar maps, by using, as training data, the positions where dangerous situations are present. Thus, a trained neural network that can identify the position where a dangerous situation is present is generated.

Note that, in the embodiment of the present disclosure, as the position where a dangerous situation is present, a position in a lateral direction as viewed from the user is mainly assumed. However, the position where a dangerous situation is present is not limited to the position in the lateral direction as viewed from the user. For example, the position where a dangerous situation is present may be a position in the vertical direction as viewed from the user.

The control section 210 provides the trained neural network to the smartphone 10 via the communication section 240 and the network 50. In the smartphone 10, the acquisition section 111 acquires the trained neural network via the communication section 140. The trained neural network as described above may be used to determine whether or not a dangerous situation is present, as described below.

FIG. 6 is a diagram depicting an example of a case where no dangerous situation is present. Referring to FIG. 6, a user who is walking while watching the smartphone 10 is depicted. Additionally, referring to FIG. 6, a measurement range 70 provided by a millimeter-wave radar of the smartphone 10 is depicted. The millimeter-wave radar of the smartphone 10 sequentially radiates a millimeter wave in different directions within the measurement range 70 by beamforming. Then, the millimeter-wave radar of the smartphone 10 detects the millimeter wave reflected by an object.

A millimeter wave B1 and a millimeter wave B2 travel straight without being reflected by the ground 81 and are thus not detected by the millimeter-wave radar of the smartphone 10. On the other hand, a millimeter wave B3 (which is radiated in a direction closer to a downward direction than the radiation directions of the millimeter wave B1 and the millimeter wave B2) is reflected by the ground 81 since there is not a step ahead of the user, and is then detected by the millimeter-wave radar of the smartphone 10. The millimeter-wave radar of the smartphone 10 detects, as a millimeter-wave radar map (hereinafter also referred to as an “identification radar map”), the millimeter wave corresponding to each position. Note that the millimeter-wave radar can also detect the identification radar map several dozens of times in one second and can thus capture dynamic changes in an object present ahead.

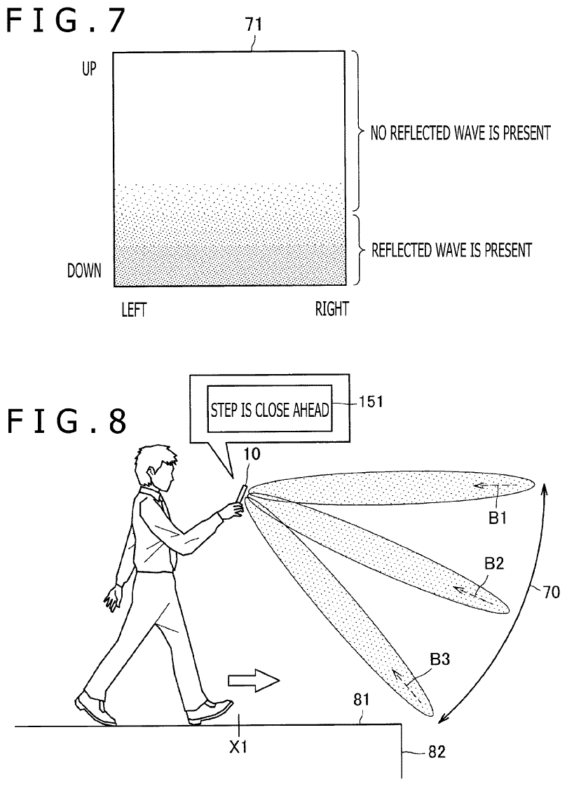

FIG. 7 is a diagram depicting an example of an identification radar map that is detected in a case where no dangerous situation is present. Referring to FIG. 7, an identification radar map 71 that is detected in a case where no dangerous situation is present is depicted. In the identification radar map 71, a region with dense dots indicates that a round-trip time from transmission of a millimeter wave until reception of the reflected millimeter wave (hereinafter simply referred to as a “round-trip time”) is short. Consequently, in the identification radar map 71, an upper region is a region with no reflected wave. On the other hand, in the identification radar map 71, a lower region is a region where the round-trip time is short and a reflected wave is present.

The acquisition section 111 acquires the identification radar map 71 detected by the millimeter-wave radar of the smartphone 10. Then, the determination section 112 determines, on the basis of the identification radar map 71, whether or not a dangerous situation is present within the measurement range 70.

Here, a determination method performed by the determination section 112 is not limited to any particular method. For example, it is sufficient if the determination section 112 determines, on the basis of the identification radar map 71 and the trained neural network, whether or not a dangerous situation is present within the measurement range 70. Specifically, by inputting the identification radar map 71 to the trained neural network, the determination section 112 can determine, from output from the trained neural network, whether or not a dangerous situation is present within the measurement range 70. In the example depicted in FIG. 6 and FIG. 7, the determination section 112 determines that no dangerous situation is present.

FIG. 8 is a diagram depicting an example of a case where a dangerous situation is present. Referring to FIG. 8, similarly to the example depicted in FIG. 6, the user who is walking while watching the smartphone 10 is illustrated. Additionally, referring to FIG. 8, similarly to the example depicted in FIG. 6, the measurement range 70 provided by the millimeter-wave radar of the smartphone 10 is illustrated. The millimeter-wave radar of the smartphone 10 sequentially radiates a millimeter wave in different directions within the measurement range 70 by beamforming. Then, the millimeter-wave radar of the smartphone 10 detects the millimeter wave reflected by an object.

Similarly to the example depicted in FIG. 6, the millimeter wave B1 and the millimeter wave B2 travel straight without being reflected by the ground 81 and are thus not detected by the millimeter-wave radar of the smartphone 10. On the other hand, in contrast to the example depicted in FIG. 6, the millimeter wave B3 (which is radiated in the direction closer to the downward direction than the radiation directions of the millimeter wave B1 and the millimeter wave B2) travels straight without being reflected by the ground 81 since there is a step 82 ahead of the user, and is not detected by the millimeter-wave radar of the smartphone 10.

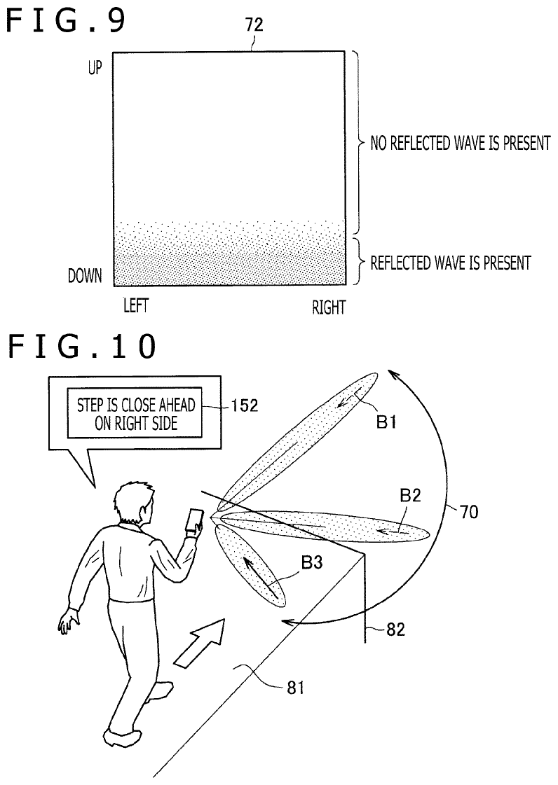

FIG. 9 is a diagram depicting an example of an identification radar map that is detected in a case where a dangerous situation is present. Referring to FIG. 9, an identification radar map 72 that is detected in a case where a dangerous situation is present is depicted. Similarly to the example depicted in FIG. 7, in the identification radar map 72, an upper region corresponds to a region with no reflected wave. However, the region with no reflected wave is larger than that in the example depicted in FIG. 7. Meanwhile, similarly to the example depicted in FIG. 7, in the identification radar map 72, a lower region is a region where the round-trip time is short and a reflected wave is present. However, the region with a reflected wave is larger than that in the example depicted in FIG. 7.

The acquisition section 111 acquires the identification radar map 72 detected by the millimeter-wave radar of the smartphone 10. Then, the determination section 112 determines, on the basis of the identification radar map 72, whether or not a dangerous situation is present within the measurement range 70.

In the example depicted in FIG. 8 and FIG. 9, the determination section 112 determines that a dangerous situation is present. Note that assumed here is a case in which the determination section 112 determines, on the basis of one identification radar map 72, whether or not a dangerous situation is present within the measurement range 70. However, as described above, the millimeter-wave radar can consecutively capture multiple identification radar maps. Thus, the determination section 112 may determine, on the basis of multiple identification radar maps 72, whether or not a dangerous situation is present within the measurement range 70. This allows more accurate determination of whether or not a dangerous situation is present within the measurement range 70.

In a case where the determination section 112 determines that a dangerous situation is present within the measurement range 70, the presentation control section 113 controls the output section 150 such that the output section 150 presents predetermined presentation information. Such a configuration makes it possible to prevent the user walking on the platform while watching the smartphone from falling down onto the railway track from the platform. Note that a timing for ending the presentation of the presentation information is not limited to any particular timing. For example, the presentation control section 113 may end the presentation of the presentation information after a predetermined period of time elapses from the start of the presentation of the presentation information. Alternatively, the presentation control section 113 may end the presentation of the presentation information in a case where a dangerous situation is no longer present within the measurement range 70.

The predetermined presentation information may include information indicating that a dangerous situation is present. Here, assumed is a case in which the presentation control section 113 causes the display to display presentation information such that the presentation information is visually perceived by the user. However, the presentation control section 113 may cause a sound output device to output presentation information (sound or the like) such that the presentation information is auditorily perceived by the user. Alternatively, the presentation control section 113 may cause a haptic-sense presentation device to output presentation information (vibration or the like) such that the presentation information is haptically perceived by the user.

Note that the predetermined presentation information may include information other than the information indicating that a dangerous situation is present. For example, in a case where a neural network that has been trained and can identify the type of a danger is generated, it is sufficient if the determination section 112 also determines the type of a danger arising within the measurement range 70, on the basis of the identification radar map 72 and the neural network that has been trained and can identify the type of a danger. At this time, the presentation control section 113 may control the output section 150 such that the type of the danger is also presented by the output section 150.

Referring to FIG. 8, depicted is an example in which the presentation control section 113 causes the output section 150 of the smartphone 10 to display a message 151 indicating the presence of a step as the type of the danger. However, as described above, the type of the danger is not limited to the presence of a step.

FIG. 10 is a diagram depicting another example of a case where a dangerous situation is present. Referring to FIG. 10, similarly to the example depicted in FIG. 8, the user who is walking while watching the smartphone 10 is illustrated. Additionally, referring to FIG. 10, similarly to the example depicted in FIG. 8, the measurement range 70 that is provided by the millimeter-wave radar of the smartphone 10 is illustrated. The millimeter-wave radar of the smartphone 10 sequentially radiates a millimeter wave in different directions within the measurement range 70 by beamforming. Then, the millimeter-wave radar of the smartphone 10 detects the millimeter wave reflected by an object.

The millimeter wave B1 travels straight without being reflected by the ground 81 and is thus not detected by the millimeter-wave radar of the smartphone 10. Meanwhile, the millimeter wave B2 (which is radiated in a direction closer to a lower right direction than the radiation direction of the millimeter wave B1) travels straight without being reflected by the ground 81 since there is the step 82 ahead of the user on the right side, and is not detected by the millimeter-wave radar of the smartphone 10.

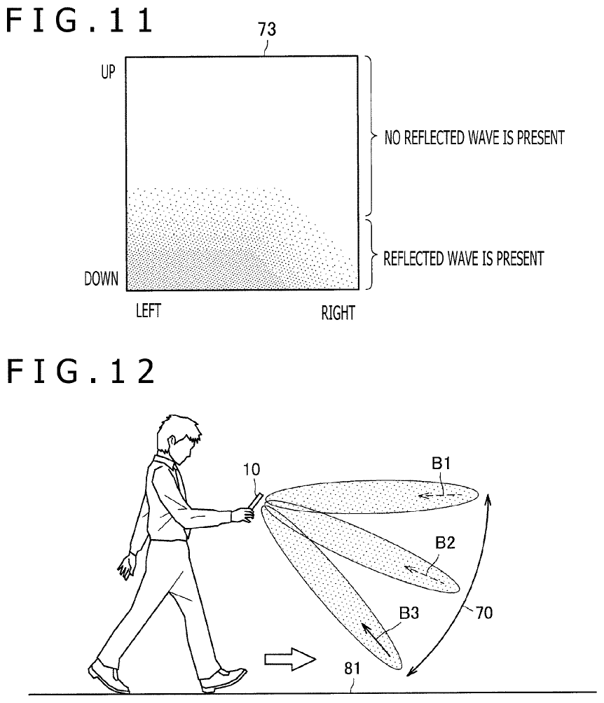

FIG. 11 is a diagram depicting an example of an identification radar map that is detected in a case where a dangerous situation is present. Referring to FIG. 11, an identification radar map 73 that is detected in a case where a dangerous situation is present is depicted. In the identification radar map 73, an upper right region is a region where an intensity of the millimeter wave is low and a reflected wave is not present. On the other hand, in the identification radar map 73, a lower left region is a region where an intensity of the millimeter wave is high and a reflected wave is present.

The acquisition section 111 acquires the identification radar map 73 detected by the millimeter-wave radar of the smartphone 10. Then, the determination section 112 determines, on the basis of the identification radar map 73, whether or not a dangerous situation is present within the measurement range 70. In the example depicted in FIG. 10 and FIG. 11, the determination section 112 determines that a dangerous situation is present. In a case where the determination section 112 determines that a dangerous situation is present within the measurement range 70, the presentation control section 113 controls the output section 150 such that the output section 150 presents predetermined presentation information.

Here, in a case where a neural network that has been trained and can identify a position where the dangerous situation is present is generated, it is sufficient if the determination section 112 also determines the position where the dangerous situation is present within the measurement range 70, on the basis of the identification radar map 73 and the neural network that has been trained and can identify the position where the dangerous situation is present. At this time, the presentation control section 113 may control the output section 150 such that the position where the dangerous situation is present is also presented by the output section 150.

Referring to FIG. 10, depicted is an example in which the presentation control section 113 causes the output section 150 of the smartphone 10 to display a message 152 indicating the position of a step as the position where a dangerous situation is present. However, as described above, the type of the danger is not limited to the position of a step.

Here, in order for the determination section 112 to accurately determine whether or not a dangerous situation is present within the measurement range 70, it is desirable to avoid changing of the measurement range 70 regardless of the orientation of the smartphone 10. Consequently, the determination section 112 may recognize the orientation of the smartphone 10 and avoid changing of the measurement range 70 regardless of the orientation of the smartphone 10. For example, in a case where the sensor section 160 includes an acceleration sensor, the determination section 112 may control the direction in which the millimeter wave is radiated, on the basis of acceleration detected by the acceleration sensor.

FIG. 12 is a diagram illustrating a case where the orientation of the smartphone 10 changes. Referring to FIG. 12, the orientation of the smartphone 10 has been changed by the user (such that a rear surface of the smartphone 10 faces downward) compared with the example depicted in FIG. 6. At this time, lack of control of the radiation direction of the millimeter wave leads to downward radiation of the millimeter wave, compared to the radiation in the example depicted in FIG. 6. Thus, as depicted in FIG. 12, the determination section 112 may recognize the orientation of the smartphone 10 and control the radiation direction of the millimeter wave in such a manner as to avoid changing of the measurement range 70 regardless of the orientation of the smartphone 10.

Additionally, the user who walks at a higher speed is assumed to reach earlier the location where the dangerous situation is present. Consequently, on the basis of the walking speed of the user and a distance from the smartphone 10 to the location where the dangerous situation is present, the distance being detected by the millimeter-wave radar, the presentation control section 113 may control the output section 150 such that the presentation information is presented by the output section 150. More specifically, as the walking speed of the user increases, the presentation control section 113 may start causing the output section 150 to present presentation information at a time when there is still a great distance between the smartphone 10 and the location where the dangerous situation is present. Note that the millimeter-wave radar can measure, for example, the distance to an object located several cm to several m ahead.

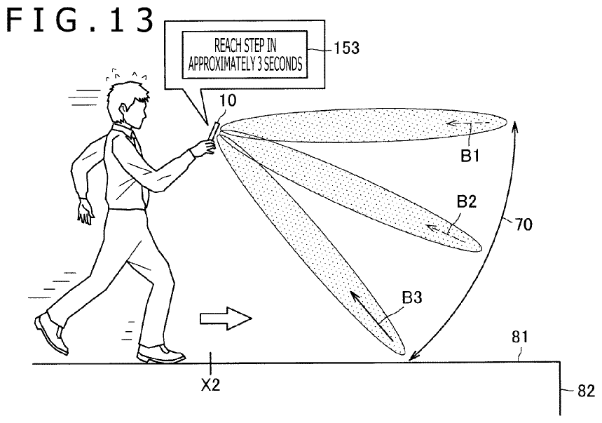

FIG. 13 is a diagram illustrating a case where the walking speed of the user changes. Referring to FIG. 13, the user is walking at a speed higher than that in the example depicted in FIG. 8. At this time, the user is assumed to reach the step 82 earlier than in the example depicted in FIG. 8. Thus, as the walking speed of the user increases, the determination section 112 may start causing the output section 150 to present presentation information at a time when there is still a great distance between the smartphone 10 and the step 82.

Specifically, in the example depicted in FIG. 8, the presentation control section 113 causes display of the message 151 indicative of the presence of a step to be started when the distance from the smartphone 10 to the step 82 is equal to X1. On the other hand, in the example depicted in FIG. 13, the presentation control section 113 causes display of a message 153 indicative of the presence of a step to be started when the distance from the smartphone 10 to the step 82 is equal to X2 (which is larger than X1).

As an example, the presentation control section 113 may calculate, on the basis of the walking speed of the user and the distance from the smartphone 10 to the step 82, a predicted time required for the user to reach the step 82. Then, in a case where the predicted time is approaching a predetermined time, the presentation control section 113 may cause the presentation information to be presented. Additionally, as depicted in FIG. 13, the presentation control section 113 may include the predicted time (three seconds later) in the message 153 indicative of the presence of a step.

The details of the functions of the system 1 according to the embodiment of the present disclosure have been described above.

### [1.4. Operation Example of System]

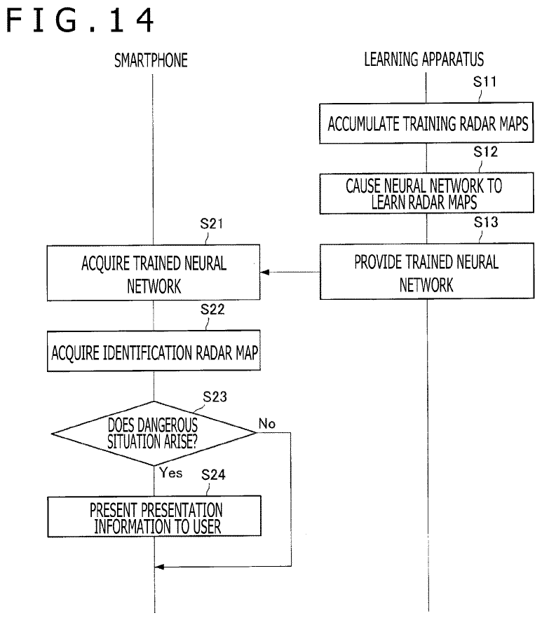

Now, an operation example of the system 1 according to the embodiment of the present disclosure will be described. FIG. 14 is a flowchart depicting the operation example of the system 1 according to the embodiment of the present disclosure.

First, when multiple training radar maps on each of which a dangerous situation is detected are input to the learning apparatus 20, the storage section 230 receives and accumulates the training radar maps (S11). Then, the control section 210 inputs the training radar maps to the neural network and causes the neural network to learn the training radar maps (S12). Thus, a trained neural network is generated. The control section 210 provides the trained neural network to the smartphone 10 via the communication section 240 and the network 50 (S13).

Subsequently, in the smartphone 10, the acquisition section 111 acquires the trained neural network via the communication section 140 (S21). The millimeter-wave radar of the smartphone 10 detects an identification radar map, and the acquisition section 111 acquires the identification radar map (S22). The determination section 112 determines, on the basis of the identification radar map, whether or not a dangerous situation is present within the measurement range (S23).

In a case of determining, on the identification radar map, that no dangerous situation is present within the measurement range (“No” in S23), the presentation control section 113 performs nothing. On the other hand, in a case of determining, on the identification radar map, that a dangerous situation is present within the measurement range (“Yes” in S23), the presentation control section 113 controls the output section 150 such that the predetermined presentation information is presented to the user (S24).

The operation example of the system 1 according to the embodiment of the present disclosure has been described above.

### 2. HARDWARE CONFIGURATION EXAMPLE

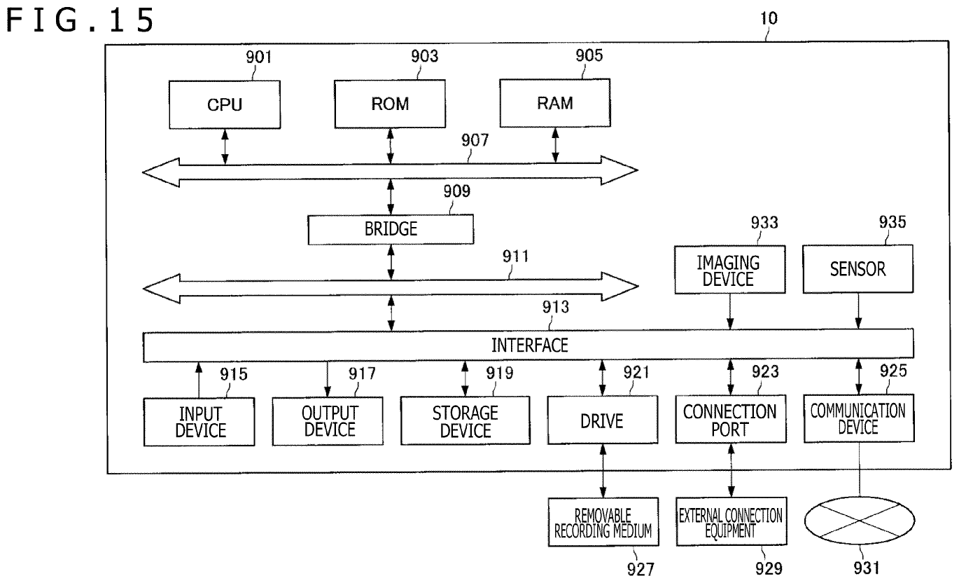

Now, with reference to FIG. 15, a hardware configuration of the smartphone 10 according to the embodiment of the present disclosure will be described. FIG. 15 is a block diagram depicting an example of the hardware configuration of the smartphone 10 according to the embodiment of the present disclosure. However, the example of the hardware configuration depicted in FIG. 15 is only an example of the smartphone 10. Consequently, for the blocks depicted in FIG. 15, unnecessary components may be deleted. Additionally, a hardware configuration of the learning apparatus 20 according to the embodiment of the present disclosure may be implemented similarly to the hardware configuration of the smartphone 10 according to the embodiment of the present disclosure.

As depicted in FIG. 15, the smartphone 10 includes a CPU (Central Processing unit) 901, a ROM (Read Only Memory) 903, and a RAM (Random Access Memory) 905. Additionally, the smartphone 10 includes a host bus 907, a bridge 909, an external bus 911, an interface 913, an input device 915, an output device 917, a storage device 919, a drive 921, a connection port 923, and a communication device 925. Further, the smartphone 10 includes an imaging device 933 and a sensor 935, as needed. The smartphone 10 may include, instead of or in addition to the CPU 901, such a processing circuit as referred to as a DSP (Digital Signal Processor) or an ASIC (Application Specific Integrated Circuit).

The CPU 901 functions as an arithmetic processing device and a control device and controls operations in general within the smartphone 10 or some of the operations according to various programs recorded in the ROM 903, the RAM 905, the storage device 919, or a removable recording medium 927. The ROM 903 stores programs, arithmetic parameters, and the like used by the CPU 901. The RAM 905 temporarily stores programs used in execution of the CPU 901, parameters varied as appropriate in the execution, and the like. The CPU 901, the ROM 903, and the RAM 905 are connected together by the host bus 907 including an internal bus such as a CPU bus. Further, the host bus 907 is connected to the external bus 911 such as a PCI (Peripheral Component Interconnect/Interface) bus via the bridge 909.

The input device 915 is, for example, a device operated by the user, such as buttons. The input device 915 may include a mouse, a keyboard, a touch panel, a switch, a lever, and the like. Additionally, the input device 915 may include a microphone that detects a voice of the user. The input device 915 may be, for example, a remote control device using infrared rays or any other radio wave, or may be external connection equipment 929 such as a cellular phone which is compatible with operation of the smartphone 10. The input device 915 includes an input control circuit that generates an input signal on the basis of information input by the user and that outputs the input signal to the CPU 901. The user operates the input device 915 to input various pieces of data to the smartphone 10 and indicate processing operations to the smartphone 10. Additionally, the imaging device 933 described below may function as an input device by imaging the motion of a hand of the user, a finger of the user, or the like. At this time, a pointing position may be determined depending on the motion of the hand or the direction of the finger.

The output device 917 includes a device that can visually or auditorily notify the user of information acquired. The output device 917 may be, for example, a display device such as an LCD (Liquid Crystal Display) or an organic EL (Electro-Luminescence) display, or may be a sound output device such as a speaker and a headphone. Additionally, the output device 917 may include a PDP (Plasma Display Panel), a projector, a hologram, a printer device, or the like. The output device 917 outputs results obtained by processing of the smartphone 10, as text or video such as images or as sound such as voice or acoustic. Additionally, the output device 917 may include a light for lightening surroundings.

The storage device 919 is a device for data storage that is configured as an example of a storage section of the smartphone 10. The storage device 919 includes, for example, a magnetic storage device such as an HDD (Hard Disk Drive), a semiconductor storage device, an optical storage device, a magneto-optical storage device, or the like. The storage device 919 stores programs executed by the CPU 901, various pieces of data, various pieces of data externally acquired, and the like.

The drive 921 is a reader/writer for the removable recording medium 927 such as a magnetic disk, an optical disc, a magneto-optical disc, or a semiconductor memory, and is built into or externally attached to the smartphone 10. The drive 921 reads information recorded in the attached removable recording medium 927 and outputs the information to the RAM 905. Additionally, the drive 921 writes records into the attached removable recording medium 927.

The connection port 923 is a port through which equipment is connected directly to the smartphone 10. The connection port 923 may be, for example, a USB (Universal Serial Bus) port, an IEEE 1394 port, a SCSI (Small Computer System Interface) port, or the like. Additionally, the connection port 923 may be an RS-232C port, a photoacoustic terminal, an HDMI (registered trademark) (High-Definition Multimedia Interface) port, or the like. The external connection equipment 929 is connected to the connection port 923 to allow various pieces of data to be exchanged between the smartphone 10 and the external connection equipment 929.

The communication device 925 is, for example, a communication interface including a communication device or the like to be connected to a network 931. The communication device 925 may be, for example, a communication card for a wired or wireless LAN (Local Area Network), Bluetooth (registered trademark), or a WUSB (Wireless USB), or the like. Additionally, the communication device 925 may be a router for optical communication, a router for ADSL (Asymmetric Digital Subscriber Line), a modem for various communications, or the like. The communication device 925 transmits and receives signals and the like to and from the Internet or other communication equipment by using a predetermined protocol such as a TCP/IP. In addition, the network 931 connected to the communication device 925 is a network connected to the communication device 925 in a wired or wireless manner, and is, for example, the Internet, a home LAN, infrared communication, radio wave communication, satellite communication, or the like.

The imaging device 933 is, for example, a device that uses various members including an imaging element such as a CCD (Charge Coupled Device) or a CMOS (Complementary Metal Oxide Semiconductor) and a lens for controlling formation of a subject image on the imaging element, to image a real space and generate a captured image. The imaging device 933 may capture still images or moving images.

The sensor 935 is, for example, any of various sensors such as a distance measurement sensor, an acceleration sensor, a gyro sensor, a geomagnetic sensor, a vibration sensor, an optical sensor, and a sound sensor. The sensor 935 acquires, for example, information related to the state of the smartphone 10 itself such as the orientation of housing of the smartphone 10, and information related to surrounding environments of the smartphone 10 such as brightness and noise around the smartphone 10. Additionally, the sensor 935 may include a GPS (Global Positioning System) sensor that receives GPS signals and measures the latitude, longitude, and altitude of the apparatus.

### 3. CONCLUSION

As described above, according to the embodiment of the present disclosure, provided is an information processing apparatus including a determination section that determines whether or not a dangerous situation is present within a predetermined measurement range, on the basis of a detection result of a millimeter wave sequentially radiated in different directions within the measurement range by beamforming, and a presentation control section that performs, in a case where the determination section determines that the dangerous situation is present within the measurement range, control such that predetermined presentation information is presented.

According to such a configuration, since a millimeter-wave radar is used, it is possible to determine whether or not a dangerous situation is present, while reducing power consumption of the sensor. Additionally, according to the configuration as described above, since the millimeter-wave radar is used, it is possible to determine whether or not a dangerous situation is present, by using a small-scale sensor. Further, according to the configuration as described above, since the millimeter-wave radar is used, it is possible to determine whether or not a dangerous situation is present, while improving responsiveness of the sensor.

Additionally, according to the configuration as described above, since processing required to determine whether or not a dangerous situation is present is simplified, it is possible to reduce the processing time. Further, in a case where a sensor for position measurement is used, measuring the user position may be difficult depending on where the user is. On the other hand, according to the configuration as described above, it is possible to achieve more reliable determination of whether or not a dangerous situation is present.

The preferred embodiment of the present disclosure has been described above in detail with reference to the accompanying drawings. However, the technical scope of the present disclosure is not limited to such examples. It is obvious that a person having ordinary knowledge in the technical field of the present disclosure could conceive various changed or modified examples within the technical concepts set forth in claims, and needless to say, it is understood that the changed or modified examples belong to the technical scope of the present disclosure.

For example, in a case where the above-described operations of the smartphone 10 are achieved, the positions of the components are not limited to any particular position. As a specific example, some or all of the blocks of the control section 110 may be present in a server or the like. For example, if high-speed communication is achieved between the smartphone 10 and the server, the determination section 112 may be included in the server instead of being included in the smartphone 10.

Additionally, the effects described herein are descriptive or illustrative and not restrictive. In other words, in addition to or instead of the above-described effects, the techniques according to the present disclosure may produce other effects that are clear to a person skilled in the art from the description herein.

Note that configurations described below also belong to the technical scope of the present disclosure.

(1)

An information processing apparatus including:

a determination section that determines whether or not a dangerous situation is present within a predetermined measurement range, on the basis of a detection result of a millimeter wave sequentially radiated in different directions within the measurement range by beamforming; and

a presentation control section that performs, in a case where the determination section determines that the dangerous situation is present within the measurement range, control such that predetermined presentation information is presented.

(2)

The information processing apparatus according to (1) described above, in which

the determination section determines whether or not the dangerous situation is present within the measurement range, on the basis of the detection result and a trained neural network.

(3)

The information processing apparatus according to (1) or (2) described above, in which

the determination section controls a corresponding one of the directions in which the millimeter wave is radiated, on the basis of acceleration detected by an acceleration sensor.

(4)

The information processing apparatus according to any one of (1) to (3) described above, in which

the presentation control section performs control such that the predetermined presentation information is presented, on the basis of a walking speed of a user and a distance to a location where the dangerous situation is present.

(5)

The information processing apparatus according to (4) described above, in which,

as the walking speed of the user increases, the presentation control section starts causing the predetermined presentation information to be presented at a time when there is still a great distance to the location where the dangerous situation is present.

(6)

The information processing apparatus according to (4) described above, in which

the presentation control section calculates, on the basis of the walking speed of the user and the distance to the location where the dangerous situation is present, a predicted time required for the user to reach the location where the dangerous situation is present, to perform control such that the predicted time is presented.

(7)

The information processing apparatus according to any one of (1) to (6) described above, in which

the determination section determines a type of the danger, and

the presentation control section performs control such that the type of the danger is presented.

(8)

The information processing apparatus according to any one of (1) to (7) described above, in which

the determination section determines a position where the dangerous situation is present, and

the presentation control section performs control such that the position where the dangerous situation is present is presented.

(9)

The information processing apparatus according to any one of (1) to (8) described above, in which

the presentation control section performs control such that the predetermined presentation information is presented by a display, a sound output device, or a haptic-sense presentation device.

(10)

An information processing method including:

determining whether or not a dangerous situation is present within a predetermined measurement range, on the basis of a detection result of a millimeter wave sequentially radiated in different directions within the measurement range by beamforming; and

performing, in a case of determining that the dangerous situation is present within the measurement range, control such that predetermined presentation information is presented.

### REFERENCE SIGNS LIST

1: System
10: Smartphone
110: Control section
111: Acquisition section
112: Determination section
113: Presentation control section
120: Operation section
130: Storage section
140: Communication section
150: Output section
160: Sensor section
20: Learning apparatus
210: Control section
220: Operation section
230: Storage section
240: Communication section
250: Output section
50: Network
70: Measurement range

1. An information processing apparatus comprising:
a determination section that determines whether or not a dangerous situation is present within a predetermined measurement range, on a basis of a detection result of a millimeter wave sequentially radiated in different directions within the measurement range by beamforming; and
a presentation control section that performs, in a case where the determination section determines that the dangerous situation is present within the measurement range, control such that predetermined presentation information is presented.

2. The information processing apparatus according to claim 1, wherein
the determination section determines whether or not the dangerous situation is present within the measurement range, on a basis of the detection result and a trained neural network.

3. The information processing apparatus according to claim 1, wherein
the determination section controls a corresponding one of the directions in which the millimeter wave is radiated, on a basis of acceleration detected by an acceleration sensor.

4. The information processing apparatus according to claim 1, wherein
the presentation control section performs control such that the predetermined presentation information is presented, on a basis of a walking speed of a user and a distance to a location where the dangerous situation is present.

5. The information processing apparatus according to claim 4, wherein,
as the walking speed of the user increases, the presentation control section starts causing the predetermined presentation information to be presented at a time when there is still a great distance to the location where the dangerous situation is present.

6. The information processing apparatus according to claim 4, wherein
the presentation control section calculates, on the basis of the walking speed of the user and the distance to the location where the dangerous situation is present, a predicted time required for the user to reach the location where the dangerous situation is present, to perform control such that the predicted time is presented.

7. The information processing apparatus according to claim 1, wherein
the determination section determines a type of the danger, and
the presentation control section performs control such that the type of the danger is presented.

8. The information processing apparatus according to claim 1, wherein
the determination section determines a position where the dangerous situation is present, and
the presentation control section performs control such that the position where the dangerous situation is present is presented.

9. The information processing apparatus according to claim 1, wherein
the presentation control section performs control such that the predetermined presentation information is presented by a display, a sound output device, or a haptic-sense presentation device.

10. An information processing method comprising:
determining whether or not a dangerous situation is present within a predetermined measurement range, on a basis of a detection result of a millimeter wave sequentially radiated in different directions within the measurement range by beamforming; and
performing, in a case of determining that the dangerous situation is present within the measurement range, control such that predetermined presentation information is presented.
